(19) United States
(12) Patent Application Publication
(10) Pub. No.: US 2007/0246875 A1
(43) Pub. Date: Oct. 25, 2007

(54) Device for Clamping Workpieces Undergoing Mechanical Machining and a Machine Tool Incorporating the Device

(76) Inventors: Roberto Sammartin, Selvazzano (IT); Antonio Fassina, Villanova Di (IT)

Correspondence Address: RATNERPRESTIA, P O BOX 980, VALLEY FORGE, PA, 19482-0980, US

(21) Appl. No.: 11/630,639

(22) PCT Filed: Jan. 24, 2005
(86) PCT No.: PCT/IT05/00034

§ 371 Date: Dec. 22, 2006

(30) Foreign Application Priority Data
Jun. 29, 2004 (IT) PD2004A000171

(51) Int. Cl. B25B 11/00

(52) U.S. Cl. 269/8

(57) ABSTRACT

A device is provided for clamping workpieces which are subjected to mechanical machining including a device for centering the workpiece on a workpiece holder with respect to an axis (X) about which the holder is caused to rotate during mechanical machining of the workpiece, and a device for clamping the workpiece relative to the workpiece holder, in which the clamping device includes at least one member supporting the workpiece secured to the rotating holder and releasably secured to the workpiece by magnetic attraction.

This application is a U.S. National Phase Application of PCT International Application PCT/IT2005/000034 which is incorporated by reference herein.

### TECHNICAL FIELD

This invention relates to a device for clamping workpieces undergoing mechanical machining and includes means for centering the workpiece on the workpiece holder with respect to an axis (X) around which the holder is caused to rotate during mechanical machining of the workpiece, and means for clamping the workpiece relative to the workpiece holder. The invention also relates to a machine tool incorporating a device of the aforesaid type.

### BACKGROUND OF THE INVENTION

The invention relates in particular, if not exclusively, to the specific technical environment of mechanical machining, for example turning or other surface finish machining operations, in particular of axially symmetrical mechanical parts such as brake discs for vehicles.

In this context it is provided that the semi-finished brake disc is subjected to mechanical machining cycles through the removal of turnings, mainly turning of the opposing friction surfaces of the disc after the semi-finished product has been centred and clamped on a workpiece holder which is caused to rotate, for example by being mounted on a rotating arbour.

Clamping devices of the known type generally comprise three or six centering members which are angularly spaced apart in a uniform way and act along radial directions with respect to the axis of rotation of the workpiece holder, through which the semi-finished workpiece is centred and held clamped in the centred position in the course of mechanical machining. In this case the radial clamping forces produced by the centering devices must be of sufficient magnitude to immobilize the workpiece and also oppose the stresses of a centrifugal nature generated through the effect of the workpiece's rotation. It follows that the radial clamping forces will necessarily adopt rather high values which may give rise to undesired deformation of the workpiece with the consequence of possible flatness and out-of-parallel errors, which in some cases might even exceed acceptable tolerance limits, thus giving rise to the rejection of the part.

In addition to this, the centering devices have a range of travel of a few millimetres. It follows that when a workpiece is changed the pieces in contact with the workpiece (clamps) must be changed, with a consequent loss of time and costs for the various clamps and supports necessary for the required assembly.

### BRIEF DESCRIPTION OF THE INVENTION

The problem underlying this invention is that of providing a device for clamping workpieces subjected to mechanical machining which is structurally and functionally designed to overcome the limitations complained of with reference to the known art mentioned.

This problem is resolved by the present invention through a device for clamping workpieces subjected to mechanical machining, which include means for centering the workpiece on a workpiece with respect to an axis (X) around which the holder is caused to rotate during mechanical machining of the workpiece. The device also includes means for clamping the workpiece relative to the workpiece holder, and the clamping means includes at least one member supporting the workpiece which is secured to the rotating holder and which can be releasably secured to the workpiece through magnetic attraction.

### BRIEF DESCRIPTION OF THE DRAWINGS

Other advantages and characteristics of the present invention will become apparent from the following detailed description which is given with reference to the appended drawings which are provided purely by way of non-limiting example and in which:

FIG. 1 is a diagrammatical view in axial cross-section of a device constructed according to the present invention,

FIG. 2 is a diagrammatical view in translational elevation of a machine tool equipped with a device constructed according to the present invention,

FIG. 3 is a view corresponding to that in FIG. 1 of a variant of the device according to the present invention.

### PREFERRED EMBODIMENTS OF THE INVENTION

With reference to the aforesaid figures, 1 indicates as a whole a device for the centered clamping of mechanical workpieces subjected to mechanical machining on a workpiece holder 2, which is for example provided with an arbour 3 rotating about an axis X.

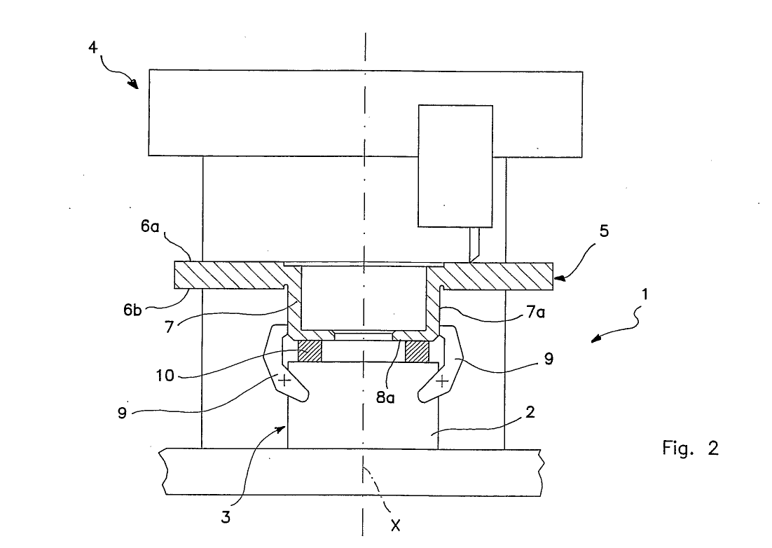

As indicated diagrammatically in FIG. 2, device 1 is to be understood to be incorporated in a machine tool 4, in which one or more tools are controlled in association with arbour 3 to effect mechanical machining of the workpiece (for example surface turning) according to specified work cycles.

Although the device according to the invention is described below with particular reference to the clamping of semi-finished brake discs 5 for vehicles, this example is not to be understood in restrictive terms, merely representing a preferred application. Device 1 can therefore likewise be used in all those applications in which the surface mechanical machining of workpieces having substantial geometrical axial symmetry is required.

Brake disc 5 has an annular portion having opposing surfaces 6a, 6b (which are capable of acting together with the jaws of the brake when in use) and a central portion including a skirt 7 with a cylindrical outer surface 7a, one extremity of which rises transversely from the annular portion and the other extremity of which is connected to an end wall 8 which extends transversely to the cylindrical skirt and is pierced at the center. This wall 8, comprising the portion for attachment of the brake disc to the hub of the vehicle's wheel, is defined outside skirt 7 by a surface 8a in the shape of an annular crown.

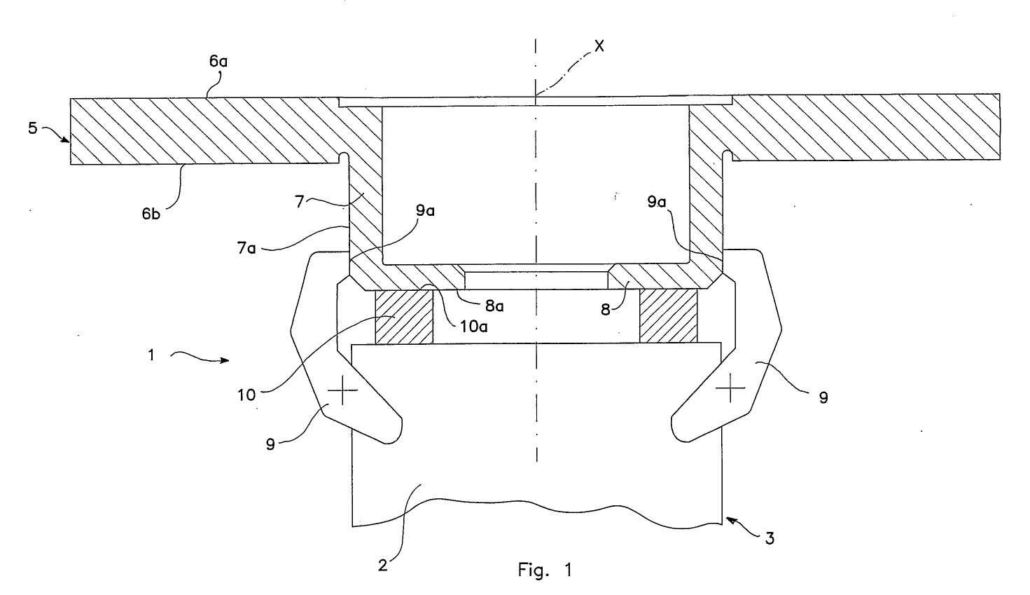

In order to center the workpieces requiring machining on holder 2, device 1 comprises three (or alternatively six) centering members constructed in the form of corresponding clamps 9, diagrammatically illustrated in FIG. 1, which are slidably or rockably mounted on holder 2 with a regular angular spacing (1200 from each other in the case of three centering members). Each centering member 9 acts through one extremity 9a on surface 7a of the disc along a predetermined radial direction relative to axis X.

Device 1 is also provided with means for clamping the brake disc (or other workpiece) on holder 2 which comprise a supporting member having a circular ring 10 on which the brake disc is supported and subsequently clamped through clamping of a magnetic nature as described in detail below.

More particularly ring 10, which is preferably of circular shape, is secured to holder 2 (in ways similar to those specified or a conventional self-centering clamping device) with its own main geometrical axis coaxial with axis X and can be secured to the brake disc through the force of magnetic attraction.

The contact between ring 10 and disc 5 takes place through a translational surface of the ring, indicated by 10a in FIG. 1, and the frontal surface 8a of the disc. When in operation the semi-finished brake disc 5 is first supported (through surface 8a or another surface, where necessary, which has previously been cleaned for example through the use of air jets) on surface 10a of ring 10 (without inducing any magnetic attraction). Through the combined action of centering members 9, the semi-finished product is centered with respect to the X axis (there is relative movement between surfaces 8a and 10a at this stage). Once the desired centred position of the disc has been identified and reached the magnetic attraction force is induced in ring 10 with consequent magnetic clamping of disc 5 on holder 2. It should be noted that in this case the magnetic clamping forces act axially along directions substantially parallel to the X axis and do not therefore induce any clamping stresses acting radially on the disc, and particularly at the points of contact with centering members 9.

Once the magnetic clamping forces have reached their preset value, workpiece holder 2 of arbour 3 is caused to rotate about the X axis under the predetermination rotation conditions required to carry out the intended mechanical machining, in particular the turning and surface finishing of opposing disc surfaces 6a, 6b.

Once the predetermined working cycle has been carried out the machined workpiece is disengaged from device 1 by reducing the magnetic clamping forces in ring 10 to zero and suitably withdrawing centering members 9 from outer skirt 7 of the disc.

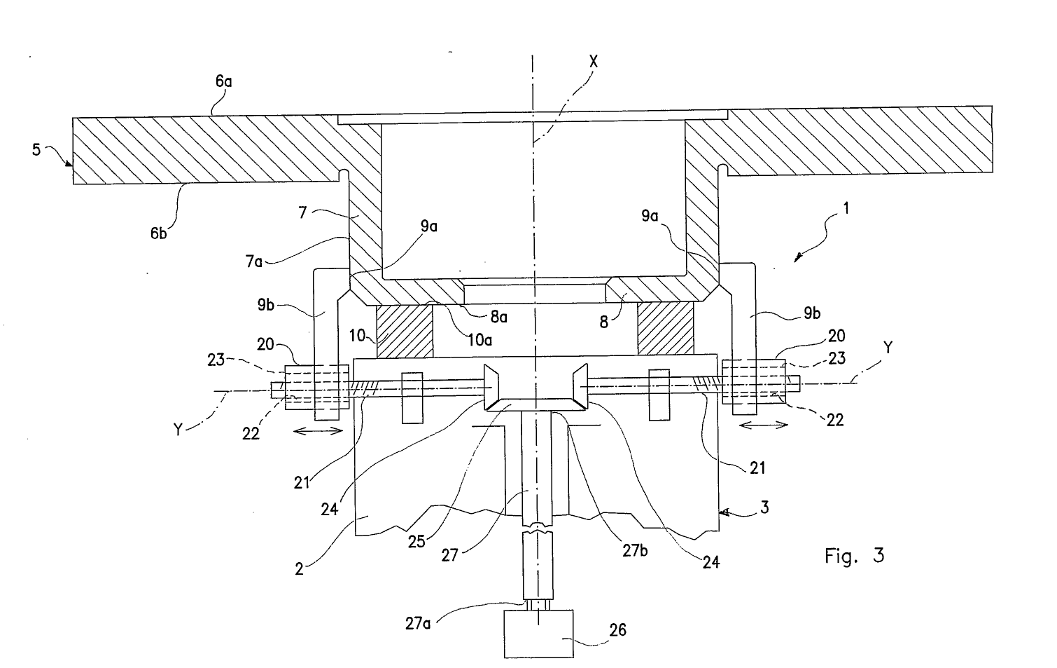

With reference to FIG. 3, which diagrammatically illustrates a variant of the device according to this invention, and in which details which are similar to those in the preceding example are indicated by the same numerical reference numbers, it is provided that the centering members, indicated by 9b, are secured to corresponding slides 20 which are slidably guided along directions (indicated by Y) which are radial to the central geometrical axis X of the device in a translational movement towards and away from axis X.

Again in this variant centering members 9b are structurally identical and therefore only one of these will be described in detail below. Corresponding actuator means constructed in the form of an operating rod 21 extending axially parallel to radial direction Y of corresponding centering member 9b and rotatably supported on holder 2 is provided for the movement of each slide 20. Rod 21 has an outside thread along its axial length and the corresponding thread is connected to a corresponding nut 22 which is secured to slide 20. More particularly the aforesaid thread is of the spherical recycling type and the corresponding attachment nut is set in a block 23 which is secured to slide 20. It follows that manoeuvring rotational movement of rod 21 is converted into a translational movement of block 23 and, of one piece therewith, slide 20, with consequent movement of centering member 9b in the corresponding radial direction Y towards and away from the X axis.

The device also comprises transmission means including corresponding gears 24 keyed to a free end of the rod in each manoeuvring rod 21. Gears 24 engage a common gearwheel 25 in such a way that the rotational motion of gearwheel 25 is synchronously transmitted to manoeuvring rods 21. Devices which are in themselves known are also provided to take up or eliminate play in the moving connections present.

Conveniently each gear 24 together with gearwheel 25 forms a pair of gears which are at right angles to each other in the form of a tapering wheel/pinion. A drive unit indicated as a whole by 26 is also provided, and this is operatively associated with an axial extremity 27a of a transmission shaft 27 which is keyed to gearwheel 25 at the opposite axial extremity 27b. Shaft 27 extends coaxially with principal axis X from the side opposite clamping ring 10 with respect to the operating part centering and clamping the workpiece and is preferably constructed as an axially hollow tubular structure. It follows that drive unit 26 is therefore located beneath holder 2.

A pair of pulleys (not shown) which are keyed to shaft 27 and the drive output shaft respectively may conveniently be provided to transmit motion to shaft 26, with a transmission belt (not shown) forming a closed ring around them. It remains understood that kinetic transmissions which are equivalent to the aforesaid belt transmission may be provided as an alternative between drive unit 26 and shaft 27.

In operation, after shaft 27 has been set in rotation through operating drive unit 26, rotational movement is transmitted to manoeuvring rod 21 through tapering pair of gears 24, 25, this movement in turn bringing about radial movement of centering members 9b (in radial direction Y) towards and away from the X axis to contact surface 7a of the disc with the corresponding extremities 9a of the centering members in the operation of centering the disc before clamping the latter against ring 10.

The invention thus resolves the problem stated and brings about many advantages in comparison with known arrangements.

One principal advantage lies in the fact that because the main magnetic forces clamping the workpiece on the workpiece holder are directed parallel to the axis of the disc and not radially thereto, no substantial radial deformation is induced in the disc and therefore there is no risk of imparting substantial deformation thereto. Clamping according to the invention does not therefore influence accuracy, generally ensuring that the required flatness and parallelism tolerances are achieved.

Thanks to the required action of clamping the part on the magnetic ring, the forces acting radially on the part are limited to the moderate stresses required when centering the disc through the action of the centering members, without therefore having any substantial influence on the accuracy of the machining carried out, in particular in the radial direction.

It is furthermore advantageously possible to rotate the device at a high rotation speed thus making better use of the cutting speeds available, as a consequence reducing cycle time and achieving greater productivity. There is also the advantage of flexibly machining discs of different types and sizes (typical of machining when workpieces are fed in a random sequence) using the same equipment without requiring any changes or re-equipping of the same.

Although the illustrative embodiments of the present invention has been described in detail with reference to the accompanying drawings, it is to be understood that the invention is not limited to these precise embodiments and that various changes or modifications may be effected therein by one skilled in the art without departing from the scope or spirit of the invention.

1. A device for clamping workpieces subjected to mechanical machining, comprising:
means for centering the workpiece on a workpiece holder with respect to an axis (X) around which the holder is caused to rotate during mechanical machining of the workpiece,
means for clamping the workpiece relative to the workpiece holder, and the clamping means comprise at least one member supporting the workpiece which is secured to the rotating holder and which can be reversibly secured to the workpiece through magnetic attraction.

2. The device according to claim 1, in which the supporting member for magnetically clamping the workpiece is located with respect to the workpiece in such a way that magnetic clamping forces mainly act along directions substantially parallel to the axis (X) of rotation of the workpiece holder.

3. The device according to claim 1, in which the supporting member for magnetically clamping the workpiece is in the form of a ring with its main geometrical axis being coaxial with the axis (X) of rotation of the workpiece holder.

4. The device according to claim 3, in which the supporting member comprises opposing translational surfaces, one of which is capable of acting together with a corresponding surface of the workpiece to ensure mutual magnetic clamping.

5. The device according to claim 3, in which the supporting member has a circular shape with its main axis of symmetry coaxial with the axis (X) of rotation of the workpiece holder.

6. The device according to claim 1, in which the centering means comprise at least three centering members which act on the workpiece along directions which are radial to the axis (X) of rotation of the workpiece holder and which are angularly spaced apart in a regular manner.

7. The device according to claim 6, in which the centering means are rockably mounted on the workpiece holder.

8. The device according to claim 6, in which the centering members are slidably mounted on the workpiece holder, each of the centering members being capable of movement in a predetermined radial direction (Y), these radial directions intersecting at the geometrical axis (X) of rotation of the workpiece holder, actuator means being associated with each centering member, respectively, for operating control of the centering member during translational movement along the corresponding radial direction (Y), and comprising for each centering member a corresponding rod-shaped control member which can be caused to move in rotation, as well as first means for transmission of the motion which are capable of converting the rotational movement of the control member into a translational movement of the corresponding centering member along the corresponding radial direction (Y), second means for transmission of the movement being provided between the control members and a drive unit in such a way that a rotational movement is transmitted synchronously to each of the control members, consequently bringing about a synchronised translational movement of the centering members along the respective radial translational directions (Y).

9. A machine tool comprising a rotating workpiece holder to support a workpiece which is at least subjected to mechanical machining and a device for clamping workpieces undergoing machining on the workpiece holder accordance with claim 1.

10. The device according to claim 2, in which the supporting member for magnetically clamping the workpiece is in the form of a ring with its main geometrical axis being coaxial with the axis (X) of rotation of the workpiece holder.

11. The device according to claim 4, in which the supporting member has a circular shape with its main axis of symmetry coaxial with the axis (X) of rotation of the workpiece holder.

12. The device according to claim 2, in which the centering means comprise at least three centering members which act on the workpiece along directions which are radial to the axis (X) of rotation of the workpiece holder and which are angularly spaced apart in a regular manner.

13. The device according to claim 3, in which the centering means comprise at least three centering members which act on the workpiece along directions which are radial to the axis (X) of rotation of the workpiece holder and which are angularly spaced apart in a regular manner.

14. The device according to claim 4, in which the centering means comprise at least three centering members which act on the workpiece along directions which are radial to the axis (X) of rotation of the workpiece holder and which are angularly spaced apart in a regular manner.

15. The device according to claim 5, in which the centering means comprise at least three centering members which act on the workpiece along directions which are radial to the axis (X) of rotation of the workpiece holder and which are angularly spaced apart in a regular manner.

16. A machine tool comprising a rotating workpiece holder to support a workpiece which is at least subjected to mechanical machining and a device for clamping workpieces undergoing machining on the workpiece holder in accordance with claim 2.

17. A machine tool comprising a rotating workpiece holder to support a workpiece which is at least subjected to mechanical machining and a device for clamping workpieces undergoing machining on the workpiece holder in accordance with claim 3.

18. A machine tool comprising a rotating workpiece holder to support a workpiece which is at least subjected to mechanical machining and a device for clamping workpieces undergoing machining on the workpiece holder in accordance with claim 4.

19. A machine tool comprising a rotating workpiece holder to support a workpiece which is at least subjected to mechanical machining and a device for clamping workpieces undergoing machining on the workpiece holder in accordance with claim 5.

20. A machine tool comprising a rotating workpiece holder to support a workpiece which is at least subjected to mechanical machining and a device for clamping workpieces undergoing machining on the workpiece holder in accordance with claim 6.

21. A machine tool comprising a rotating workpiece holder to support a workpiece which is at least subjected to mechanical machining and a device for clamping workpieces undergoing machining on the workpiece holder in accordance with claim 7.

22. A machine tool comprising a rotating workpiece holder to support a workpiece which is at least subjected to mechanical machining and a device for clamping workpieces undergoing machining on the workpiece holder in accordance with claim 8.

23. A device for clamping workpieces subjected to mechanical machining, comprising:
means for centering the workpiece on a workpiece holder with respect to an axis (X) around which the holder is caused to rotate during mechanical machining of the workpiece,
means for clamping the workpiece relative to the workpiece holder, and the clamping means comprise at least one member supporting the workpiece which is secured to the rotating holder and which can be releasably secured to the workpiece through magnetic attraction.
